(19) United States
(12) Patent Application Publication
(10) Pub. No.: US 2016/0379293 A1
(43) Pub. Date: Dec. 29, 2016

(54) APPLICATION FOR AUTOMATIC ORDERING OF FOOD ITEMS

(71) Applicant: International Business Machines Corporation, Armonk, NY (US)

(72) Inventors: Emmanuel Barajas Gonzalez, Jalisco (MX); Shaun E. Harrington, Sahuarita, AZ (US); David C. Reed, Tucson, AZ (US); Max D. Smith, Tucson, AZ (US)

(21) Appl. No.: 14/753,392

(22) Filed: Jun. 29, 2015

(51) Int. Cl. G06Q 30/06

(52) U.S. Cl. CPC G06Q 30/0631; G06Q 50/12

(57) ABSTRACT

Aspects of the present invention disclose a method for automatic ordering of food from a restaurant. In one aspect, the method includes determining at least one suggested restaurant from a plurality of restaurants based on a history of the user, at least one recent activity of the user, and information about the plurality of restaurants.

### BACKGROUND OF THE INVENTION

The present invention relates generally to the field of software applications, and more particularly to an application for automatic ordering of food items.

It is well understood that people are creatures of habit. For example, consider an individual who orders a pepperoni pizza for dinner every Wednesday evening and who picks it up from the restaurant on the drive home. Today, the individual must remember to place the order for the pepperoni pizza either by phone, on-line, or with an available application. The order must be placed at the appropriate time such that the pepperoni pizza is ready when the individual arrives at the restaurant. If the order is placed too early, the pepperoni pizza will sit and possibly get cold waiting for the individual to pick it up. Or it may be sold to another customer if the individual takes too long picking it up. If the order is placed too late, the individual must sit and wait while the pepperoni pizza finishes cooking in the oven. If an application were available to remind the individual to place this routine order each Wednesday, most of those potential problems may be avoided.

### SUMMARY

Aspects of the present invention disclose a method for automatic ordering of food from a restaurant. In one aspect, the method includes determining at least one suggested restaurant from a plurality of restaurants based on a history of the user, at least one recent activity of the user, and information about the plurality of restaurants. An advantage of this method is basing a food order on the actual experiences of the user.

In another aspect, the method further includes transmitting an order for food to a selected restaurant of the at least one suggested restaurant based on an indication from the user accepting the order for food from the selected restaurant. An advantage of this method is having a plurality of restaurants from which to place a food order.

In yet another aspect, a computer program product includes program instructions to automatically order food from a restaurant. The computer program product also includes program instructions to determine at least one suggested restaurant from a plurality of restaurants based on a history of the user, at least one recent activity of the user, and information about the plurality of restaurants. An advantage of this computer program product is basing a food order on the actual experiences of the user.

In yet another aspect, a computer program product includes program instructions to transmit an order for food to a selected restaurant of the at least one suggested restaurant based on an indication from the user accepting the order for food from the selected restaurant. An advantage of this computer program product is having a plurality of restaurants from which to place a food order.

In yet another aspect, a computer system includes program instructions to automatically order food from a restaurant. The computer system also includes program instructions to determine at least one suggested restaurant from a plurality of restaurants based on a history of the user, at least one recent activity of the user, and information about the plurality of restaurants. An advantage of this computer system is basing a food order on the actual experiences of the user.

In yet another aspect, a computer system includes program instructions to transmit an order for food to a selected restaurant of the at least one suggested restaurant based on an indication from the user accepting the order for food from the selected restaurant. An advantage of this computer program product is having a plurality of restaurants from which to place a food order.

### BRIEF DESCRIPTION OF THE DRAWINGS

FIG. 1 is a functional block diagram of a computing environment, in accordance with an embodiment of the present invention;

FIG. 2 is a flowchart depicting operational steps of an application that functions to automatically place an order for a food item, in accordance with an embodiment of the present invention;

FIG. 3 is a flowchart depicting operational steps of an application that functions to create a list of alternative food providers, in accordance with an embodiment of the present invention; and

FIG. 4 depicts a block diagram of the components of a computing system representative of the client device and server device of FIG. 1, in accordance with an embodiment of the present invention.

### DETAILED DESCRIPTION

Some embodiments of the present invention recognize that people easily fall into routines. For example, gathering the family together on Sunday evenings for a roast beef dinner at Mom's house. Another example may be grabbing a cup of coffee every morning for the commute to work. Yet another example may be sitting down every Tuesday evening to watch a favorite sitcom on television. Yet another example may be stopping to pick up a pepperoni pizza for dinner on the drive home after work on Wednesday nights. For some routines, a reminder may prove beneficial. And for some other routines, an application which completed some part of the routine may help to simplify one's hectic life.

Embodiments of the present invention offer a mechanism for automatically ordering food from a restaurant. For the purposes of the present invention, food may be defined as solid or liquid items to be consumed. The mechanism takes the form of an application for placing a routine or usual order with a restaurant. The application builds a database for a user based on the user's location, contact list, calendar, phone call history, browser history, use of social media and biometric feedback from the user. Consider the example of pepperoni pizza night for dinner on Wednesday. The application learns over time that a user usually orders a pepperoni pizza for dinner on Wednesdays and picks up the pepperoni pizza on the drive home after work. Assume the travel time to the pizza restaurant is twenty minutes and the preparation time for the restaurant to make and cook a pizza is fifteen minutes—the application would have the ability to automatically place an order for a pepperoni pizza five minutes after the user leaves work. The user would have the ability to accept an order as-is, to accept an order but change the details of the order, or reject (i.e., decline) an order.

The application may take other considerations into account as well. For example, the application may take a user's location into account and suggest ordering from an alternative restaurant if the user is more than a pre-defined travel time away from the user's regular restaurant. In another example, the application may consider the user's calendar and may not suggest the usual pepperoni pizza order if a dinner reservation is on the calendar for pepperoni pizza night. The application may also have the ability to accept an indication from competitor restaurants, vying for the user's business, in the form of coupons for discounts on the competitor's menu. This list is not intended to be comprehensive as there are many other features which could be included in such an application.

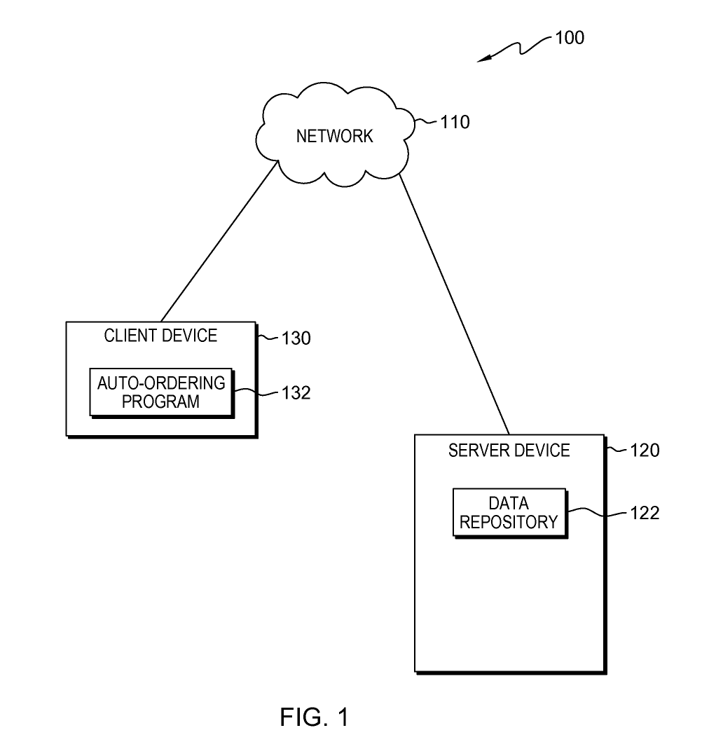

The present invention will now be described in detail with references to the Figures. FIG. 1 is a functional block diagram of a computing environment, generally designated 100, in accordance with an embodiment of the present invention.

An embodiment of computing environment 100 includes server device 120 and client device 130, interconnected over network 110. In an example embodiment, utilizing network 110, server device 120 may communicate with client device 130. In example embodiments, data processing environment 100 can include other computing devices not shown such as smartwatches, cell phones, smartphones, phablets, tablet computers, laptop computers, desktop computers, computer servers or any other computer systems known in the art.

In example embodiments, server device 120 and client device 130 may connect to network 110 which enables server device 120 and client device 130 to access other computing devices and/or data not directly stored to server device 120 and client device 130. Network 110 may be a local area network (LAN), a telecommunications network, a wide area network (WAN) such as the Internet, or any combination of the three, and include wired, wireless or fiber optic connections. In general, network 110 can be any combination of connections and protocols that will support communications between server device 120, client device 130, and other computing devices, in accordance with embodiments of the present invention.

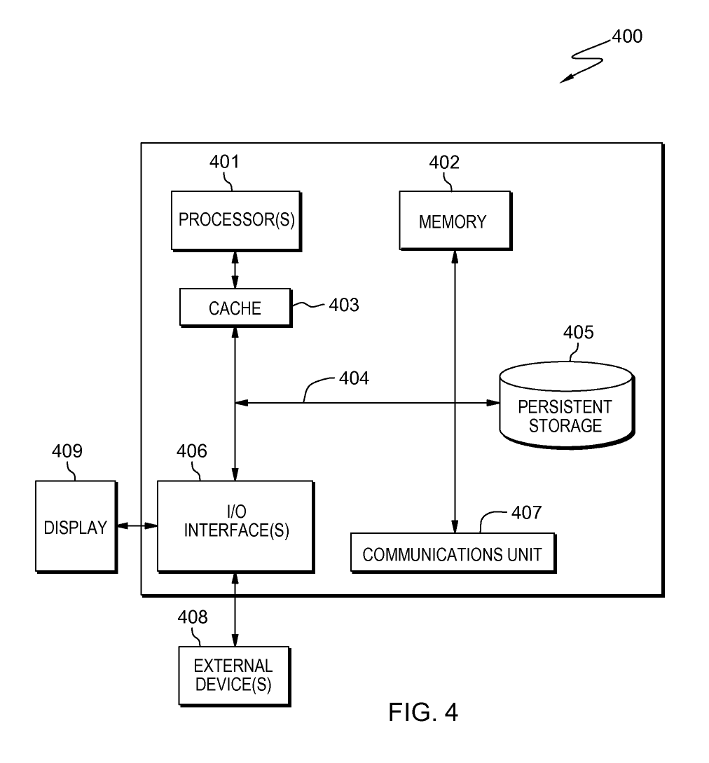

According to embodiments of the present invention, server device 120 may be a laptop, tablet or netbook personal computer (PC), a desktop computer, a personal digital assistant (PDA), a smartphone, or any programmable electronic device capable of communicating with any computing device within computing environment 100. In certain embodiments, server device 120 represents a computer system utilizing clustered computers and components (e.g., database server computers, application server computers, etc.) that act as a single pool of seamless resources when accessed by elements of computing environment 100 (e.g., client device 130). In general, server device 120 is representative of any electronic device or combination of electronic devices capable of executing computer readable program instructions. Client device 130 is substantially similar to server device 120 and has substantially similar components. Server device 120 may include components as depicted and described in further detail with respect to FIG. 4, in accordance with embodiments of the present invention.

Server device 120 includes data repository 122. In various embodiments of the present invention, server device 120 may store data, either sent or received, from client device 130, to data repository 122.

Data repository 122 may be storage that may be written to and/or read by auto-ordering program (AOP) 132. In one embodiment, data repository 122 resides on server device 120. In other embodiments, data repository 122 may reside on client device 130, in cloud storage or on another computing device accessible by AOP 132 via network 110. In yet another embodiment, data repository 122 may represent multiple storage devices within server device 120. In various embodiments, data repository 122 may be implemented as a database, a collection of files, a knowledge base, an expert system, etc., residing on a database server, a hard disk drive, flash memory, and the like. In an example embodiment, data sent or received by client device 130 may be stored to data repository 122. For example, a text message sent from a smartphone, including the message metadata (e.g., time stamp, recipient, smartphone location, etc.) may be stored to data repository 122. In another example, global positioning system (GPS) location data, browser history, social media data, and the like, may be stored to data repository 122.

Client device 130 includes auto-ordering program (AOP) 132 which may be a program, subprogram of a larger program, or application that functions to collect user data to enable auto-ordering of food a user usually orders. The user data collected by AOP 132 may include the following: calendar data; names in the user's contact list; phone call history; text message history; browser history; social media history; GPS location data; etc.

According to an embodiment of the present invention, AOP 132 may recognize a user's routine and prompt the user at the appropriate time to carry out that routine. For example, a user's routine may be to pick up a pepperoni pizza on the commute home on Wednesday's between 5:00 PM and 6:00 PM. AOP 132 may take into consideration the travel time to the restaurant (based on the user's current location) and the normal preparation time to ready the food order and prompt the user to accept placement of the order such that the food is ready when the user arrives at the restaurant.

In another embodiment, AOP 132 may query the websites of alternate restaurants looking for a better deal than the usual order. For example, AOP 132 may determine a better price for the pizza at an alternate pizza restaurant. In another example, AOP 132 may determine special deal (e.g., buy one, get one free chicken dinner) that the user finds preferable over the usual order.

In yet another embodiment, AOP 132 may consider events on a user's calendar. For example, AOP 132 may determine a dinner reservation on the user's calendar for Wednesday evening and consequently not prompt the user to accept the usual order that day. In another example, if the user has a late lunch appointment or late afternoon meeting on the user's calendar, AOP 132 may delay the prompt for the usual order to account for the difference in the normal calendar.

In yet another embodiment, AOP 132 may consider a user's location when prompting the user for the usual order. For example, if it is 5:00 PM on Wednesday but the user is driving a different route home, AOP 132 may look for an alternate location of the user's preferred pizza restaurant (restaurant ‘A’) with which to place the usual order. In another example, AOP 132 may locate a different pizza chain on the current route as an option.

In yet another embodiment, AOP 132 may consider a user's social media activity when prompting the user for the usual order. For example, AOP 132 may determine that the user has posted a comment on the user's social media page regarding the user starting a diet. In this example, AOP 132 may suggest changing the order from the regular pepperoni pizza to a food item with fewer calories. In another example, AOP 132 may query social media pages of the user's contacts who have “liked” the same restaurant(s) as the user “liked” in order to create a list of restaurant alternatives “liked” by the contacts but not yet visited by the user. In yet another example, AOP 132 may create a list of alternative restaurants similar to restaurants “liked” by the user.

In yet another embodiment, AOP 132 may determine targeted advertising applicable to a user. For example, if it is dinnertime on Tuesday, AOP 132 may request coupons for nearby restaurants for the user's consideration. AOP 132 may use the user's browser/phone call/social media history, current location, social media activity of the user's contacts, etc., to facilitate this request. The user may then decide whether to visit one of the restaurants providing coupons.

In yet another embodiment, AOP 132 may provide suggestions beyond food ordering. For example, based on identifying details about the music in the user's music library, AOP 132 may provide the user with a concert schedule for bands the user listens to. In another example, AOP 132 may determine that both a user and one of the user's contacts “liked” band ‘One’ and AOP 132 may also determine that the contact “liked” band ‘Two’; therefore, AOP 132 may suggest the user listen to band ‘Two’. In other examples, this process could be expanded to include sporting events, artistic events, area festivals, etc.

In various embodiments of the present invention, some of the features of AOP 132 may be user selectable. For example, the user may elect to not receive coupon offers from nearby restaurants. This provides the user with more control over how AOP 132 works as well as controlling how much “spam” the user receives.

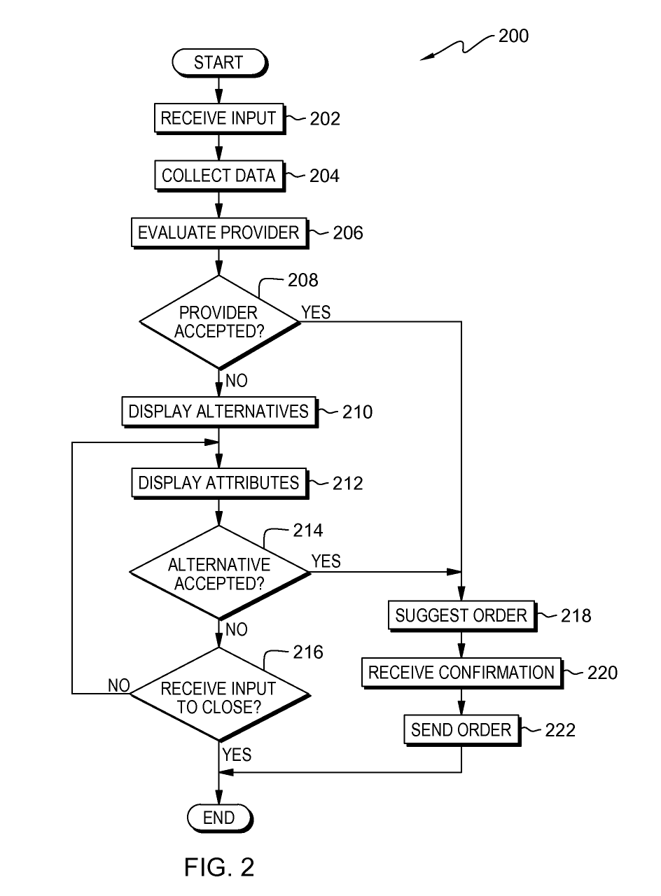

FIG. 2 is a flowchart depicting operational steps 200 of AOP 132, an application that functions to collect user data to enable auto-ordering of food the user usually orders.

AOP 132 receives input (step 202). In other words, AOP 132 collects data from a user's history. In an embodiment of the present invention, AOP 132 collects data such as the user's contact list, phone call history, text message history, browser history, social media activity, calendar information, etc., from client device 130. For example, AOP 132 collects data indicating the user has called the same pizza restaurant between 5:00 PM and 6:00 PM on every Wednesday for the past six weeks.

AOP 132 collects data (step 204). In other words, AOP 132 collects a user's current, real-time data, as opposed to the historical data collected in step 202. In various embodiments, the real-time data may include user data from at least one of the following: contact list; phone call log; browser activity; social media activity; calendar updates; biometric feedback from a device (not shown); etc. The real-time data may be used in conjunction with the historical data to determine the user's habits and routines in order to better predict the user's future wants and needs. In an embodiment, AOP 132 collects current data of a user of client device 130 and stores it to data repository 122. For example, AOP 132 determines where the user is currently located.

AOP 132 evaluates the provider (step 206). In other words, AOP 132, based on the information gleaned from step 202 and step 204, determines the preferred provider (i.e., restaurant ‘A’) and evaluates restaurant ‘A’ for a possible auto-order of food for a user. In an embodiment of the present invention, AOP 132 receives an indication of the provider's hours of operation, travel time to the provider's location from the user's current location and relevant social media activity (e.g., reviews, visitor ratings, etc.) regarding the provider. For example, AOP 132 determines the restaurant ‘A’ is currently open for business, is twenty-five minutes travel time away by car, and that the current customer rating for the provider is trending up over the last two week period of time.

AOP 132 determines whether the provider is accepted (decision step 208). In other words, AOP 132 receives an indication from a user whether to accept the auto-ordering of a food item from the preferred provider (restaurant ‘A’). In one embodiment (decision step 208, YES branch), the user accepts the auto-order; therefore, AOP 132 proceeds to step 218 to suggest the order. In another embodiment (decision step 208, NO branch), the user declines to accept the auto-order; therefore, AOP 132 proceeds to step 210.

AOP 132 displays alternatives (step 210). In other words, AOP 132 has received an indication in decision step 208 that a user has rejected the auto-order; AOP 132 therefore executes workflow 300 to determine a list of alternative providers for the user to consider. Workflow 300 involves determining a list of alternative providers by considering the relevant attributes for placing an auto-order, looking for recent social media data regarding the alternatives, and updating the list of alternatives based on that social media data. In an embodiment, AOP 132 displays the alternative providers on client device 130. For example, AOP 132 displays providers ‘X’, ‘Y’ and ‘Z’.

AOP 132 displays attributes (step 212). In other words, AOP 132 displays the pertinent attributes for the first alternate provider in the list of alternatives for a user's consideration for the food order. In an embodiment of the present invention, AOP 132 displays the business hours, food cost relative to the preferred restaurant, restaurant rating, travel distance, etc. for the first provider in the alternatives list. For example, for provider ‘X’, AOP 132 displays that the restaurant closes at 10:00 PM, that cost is within five percent of the cost at restaurant ‘A’, that the restaurant has a higher social media rating than restaurant ‘A’, and that the restaurant is forty-five minutes away from the user's current location (which is farther than the user intends to drive for dinner). In this example, the alternative is rejected.

AOP 132 determines whether the alternative is accepted (decision step 214). In other words, AOP 132 receives an indication from a user whether to accept the alternative provider. In one embodiment (decision step 214, YES branch), the user accepts the alternative; therefore, AOP 132 proceeds to step 218 to suggest the order. In another embodiment (decision step 214, NO branch), the user rejects the first alternative; therefore, AOP 132 proceeds to step 216.

AOP 132 determines whether to close (decision step 216). In other words, AOP 132 receives an indication from a user whether to close the application. In one embodiment (decision step 216, YES branch), AOP 132 receives an indication from the user to close the application; therefore, AOP 132 ends. In another embodiment (decision step 216, NO branch), AOP 132 does not receive an indication from a user to close; therefore, AOP 132 proceeds to step 212 to display the attributes for another alternative provider in the alternatives list. For example, for provider ‘Y’, AOP 132 displays that the restaurant closes at 10:00 PM, that cost is within five percent of the cost at restaurant ‘A’, that the restaurant has a higher social media rating than restaurant ‘A’, and that the restaurant is fifteen minutes away from the user's current location (which is close enough for the user to drive to for dinner). In this example, the alternative is accepted and AOP 132 proceeds to step 218.

AOP 132 suggests the order (step 218). In other words, AOP 132 has received an indication that either restaurant ‘A’ was accepted (step 208) or an alternative was accepted (step 214) and suggests the usual auto-order to the user. In an embodiment of the present invention, AOP 132 suggests the usual auto-order via client device 130 over network 110. For example, AOP 132 suggests an order for a pepperoni pizza from restaurant ‘A’. In yet another embodiment, the AOP 132 receives an advertisement, based on a recent browser search for a new restaurant, for a special offer. For example, AOP 132 suggests an order based on receiving an offer for a buy one, get one free chicken dinner special from a nearby restaurant.

AOP 132 receives confirmation (step 220). In other words, AOP 132 receives confirmation from the user of the usual auto-order from the selected provider. In an embodiment, AOP 132 receives an indication from the user on client device 130 of receiving the suggested usual auto-order. For example, the user accepts the usual order for a pepperoni pizza from restaurant ‘A’. In an alternative embodiment, AOP 132 receives an indication from the user on client device 130 of a change to the usual order. For example, the user indicates a change from pepperoni pizza to a pizza with pepperoni, sausage, and onions.

AOP 132 sends the order (step 222). In other words, based on the user's input, AOP 132 sends the order to the selected provider. In one embodiment, the user wants the usual auto-order so AOP 132 sends that order, via client device 130, to the preferred provider. For example, the user wants the usual pepperoni pizza from restaurant ‘A’. In another embodiment, the user desires a change to the usual auto-order so AOP 132 receives input of an update from client device 130 and sends an updated order to the selected provider. For example, the user wants to add sausage and onion toppings to the pepperoni pizza and inputs that change on the user's smartphone; AOP 132 then sends the updated order to the selected provider.

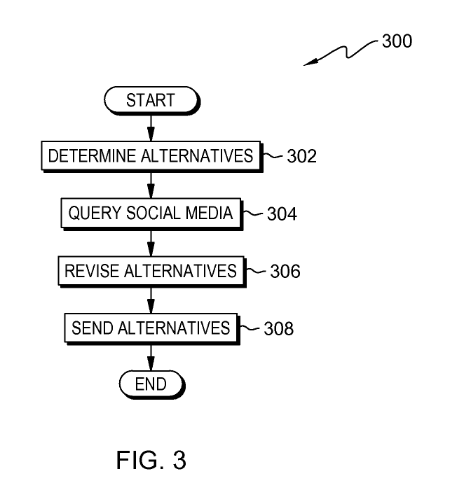

FIG. 3 is a flowchart depicting operational steps of workflow 300 of AOP 132, an application that functions to create a list of alternative providers for a food order.

AOP 132 determines alternatives (step 302). In other words, AOP 132 determines a list of alternative providers for a user to select from in the event the user does not select the preferred restaurant. In various embodiments of the present invention, AOP 132 determines a list of alternative providers based on provider attributes including the following: hours of operation; food costs relative to the preferred restaurant; distance from the user's current location; etc. For example, the alternatives program determines that a first alternative ‘X’ is open until 10:00 PM, has food cost within five percent of the cost at restaurant ‘A, and is forty-five minutes away from the user's current location. In this example AOP 132 also determines that a second alternative ‘Y’ is also open until 10:00 PM, also has food cost within five percent of restaurant ‘A’, and is within fifteen minutes of the user's current location.

AOP 132 queries social media (step 304). In other words, AOP 132 queries available social media websites for user ratings of the potential alternative providers. The most relevant ratings, if available, are those from users who rated the restaurant ‘A’ similarly to the rating provided by a user of the application AOP 132. In an embodiment, AOP 132 accesses social media websites on server device 120 over network 110. For example, AOP 132 receives an indication that both first alternative ‘X’ and second alternative ‘Y’ have higher ratings than restaurant ‘A’.

AOP 132 revises the alternatives (step 306). In other words, based on the social media ratings determined in step 304, AOP 132 re-orders the providers on the list of alternatives (if applicable). In an embodiment of the present invention, AOP 132 receives input from step 304. For example, since alternatives ‘X’ and ‘Y’ both have higher social media ratings than preferred restaurant ‘A’, there is no need to re-order the list of alternatives. In another example, if a first alternative ‘Q’ in an alternative list that includes ‘Q’, ‘R’, and ‘S’ had a lower social media rating than preferred restaurant ‘A’ while alternatives ‘R’ and ‘S’ had comparable ratings, the alternatives list would be re-ordered to display ‘R’, ‘S’, then ‘Q’.

AOP 132 sends the alternatives (step 308). In other words, AOP 132 sends the determined list of alternatives to the user for the user's consideration. In an embodiment, the alternatives program sends the alternatives list to AOP 132 for display on client device 130. For example, the alternatives list ‘X’ and ‘Y’ is sent to client device 130 for the user's consideration in selecting a food provider. In this example, alternative ‘Y’ is ultimately selected as the provider based on the location of ‘Y’ being closer to the user's current location as compared to alternative ‘X’.

FIG. 4 depicts computer system 400 which is an example of a system that includes auto-ordering program 132. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for automatic ordering of food from a restaurant, the method comprising:
determining at least one suggested restaurant for a user from a plurality of restaurants based on a history of the user, at least one recent activity of the user, and information about the plurality of restaurants.

2. The computer implemented method of claim 1, further comprising:
transmitting an order for food to a selected restaurant from the at least one suggested restaurant based on an indication from the user accepting the order for food from the selected restaurant.

3. The computer implemented method of claim 1, wherein the history of the user includes one or more of: a contact list of the user; a phone log of the user; a history of browser activity of the user; a history of social media activity of the user; a history of biometric response of the user; and a calendar of the user.

4. The computer implemented method of claim 1, wherein information about the plurality of restaurants include one or more of the following: a travel time for the user to each of the plurality of restaurants; hours of operation of each of the plurality of restaurants; and social media activity of each of the plurality of restaurants.

5. The computer implemented method of claim 4, wherein social media activity of each of the plurality of restaurants comprises: ratings for each of the plurality of restaurants; reviews for each of the plurality of restaurants; and social media activity about each of the plurality of restaurants by at least one user associated with the user.

6. The computer implemented method of claim 1, further comprising:
determining at least one alternate suggested restaurant based on receiving an indication from the user rejecting the plurality of restaurants.

7. The computer implemented method of claim 1, further comprising:
providing an order for food from a selected restaurant based on at least one advertisement from the plurality of restaurants and an indication from the user of the selected restaurant from the plurality of restaurants; and
transmitting the order for food to the selected restaurant based on receiving an indication from the user accepting the order for food from the selected restaurant.

8. A computer program product for automatic ordering of food from a restaurant, the computer program product comprising:
one or more computer readable storage media; and
program instructions stored on the one or more computer readable storage media, the program instructions comprising:
program instructions to determine at least one suggested restaurant for a user from a plurality of restaurants based on a history of the user, at least one recent activity of the user, and information about the plurality of restaurants.

9. The computer program product of claim 8, further comprising program instructions, stored on the one or more computer readable storage media, to:
transmit an order for food to a selected restaurant from the at least one suggested restaurant based on an indication from the user accepting the order for food from the selected restaurant.

10. The computer program product of claim 8, wherein the history of the user includes one or more of: a contact list of the user; a phone log of the user; a history of browser activity of the user; a history of social media activity of the user; a history of biometric response of the user; and a calendar of the user.

11. The computer program product of claim 8, wherein information about the plurality of restaurants include one or more of the following: a travel time for the user to each of the plurality of restaurants; hours of operation of each of the plurality of restaurants; and social media activity of each of the plurality of restaurants.

12. The computer program product of claim 11, wherein social media activity of each of the plurality of restaurants comprises: ratings for each of the plurality of restaurants; reviews for each of the plurality of restaurants; and social media activity about each of the plurality of restaurants by at least one user associated with the user.

13. The computer program product of claim 8, further comprising program instructions, stored on the one or more computer readable storage media, to:
determine at least one alternate suggested restaurant based on receiving an indication from the user rejecting the plurality of restaurants.

14. The computer program product of claim 8, further comprising program instructions, stored on the one or more computer readable storage media, to:
provide an order for food from a selected restaurant based on at least one advertisement from the plurality of restaurants and an indication from the user of the selected restaurant from the plurality of restaurants; and
transmit the order for food to the selected restaurant based on receiving an indication from the user accepting the order for food from the selected restaurant.

15. A computer system for automatic ordering of food from a restaurant, the computer system comprising:
one or more computer processors;
one or more computer readable storage media; and
program instructions stored on the one or more computer readable storage media for execution by at least one of the one or more computer processors, the program instructions comprising:
program instructions to determine at least one suggested restaurant for a user from a plurality of restaurants based on a history of the user, at least one recent activity of the user, and information about the plurality of restaurants.

16. The computer system of claim 15, further comprising program instructions, stored on the one or more computer readable storage media for execution by at least one of the one or more computer processors, to:
transmit an order for food to a selected restaurant from the at least one suggested restaurant based on an indication from the user accepting the order for food from the selected restaurant.

17. The computer system of claim 15, wherein the history of the user includes one or more of: a contact list of the user; a phone log of the user; a history of browser activity of the user; a history of social media activity of the user; a history of biometric response of the user; and a calendar of the user.

18. The computer system of claim 15, wherein information about the plurality of restaurants include one or more of the following: a travel time for the user to each of the plurality of restaurants; hours of operation of each of the plurality of restaurants; and social media activity of each of the plurality of restaurants.

19. The computer system of claim 18, wherein social media activity of each of the plurality of restaurants comprises: ratings for each of the plurality of restaurants; reviews for each of the plurality of restaurants; and social media activity about each of the plurality of restaurants by at least one user associated with the user.

20. The computer system of claim 15, further comprising program instructions, stored on the one or more computer readable storage media for execution by at least one of the one or more computer processors, to:
determine at least one alternate suggested restaurant based on receiving an indication from the user rejecting the plurality of restaurants.
